(19) United States
(12) Patent Application Publication
(10) Pub. No.: US 2014/0039688 A1
(43) Pub. Date: Feb. 6, 2014

(54) AIR-CONDITIONING CONTROLLING SOLUTION DISPLAYING DEVICE AND METHOD

(71) Applicant: Azbil Corporation, Tokyo (JP)

(72) Inventors: Yukako SAISU, Tokyo (JP); Mitsuhiro HONDA, Tokyo (JP)

(73) Assignee: Azbil Corporation, Tokyo (JP)

(21) Appl. No.: 13/957,040

(22) Filed: Aug. 1, 2013

(30) Foreign Application Priority Data
Aug. 1, 2012 (JP) 2012-170971

(51) Int. Cl. G05D 23/19

(52) U.S. Cl. CPC G05D 23/19
USPC 700/276

(57) ABSTRACT

An air-conditioning control solution displaying device includes an indicator calculating portion that calculates one or more indicators to evaluate similarity of the detail of air-conditioning control based on operating volumes and/or state distributions for a Pareto solution, a similarity calculating portion that calculates similarity of the Pareto solution to a reference Pareto solution, based on the indicators for the Pareto solution and the indicators for the reference Pareto solution, which is selected as a reference from Pareto solutions, a Pareto solution displaying portion that displays a plot of symbols for the individual Pareto solutions, based on evaluation values for the individual Pareto solutions, calculated by objective functions, at coordinate locations corresponding to the evaluation values on a display screen, and displays the symbols for the individual Pareto solutions differentiated in accordance with a similarity to the reference Pareto solution.

### CROSS REFERENCE TO RELATED APPLICATION

This application claims priority under 35 U.S.C. §119 to Japanese Patent Application No. 2012-170971, filed on Aug. 1, 2012, the entire content of which being hereby incorporated herein by reference.

### FIELD OF TECHNOLOGY

The present invention relates to an air-conditioning controlling technology, and, in particular, relates to an air-conditioning optimal solution displaying technology for calculating operating volumes for an air-conditioner, using a distributed system heat flow analysis method.

### BACKGROUND

In order to control and maintain an air-conditioned space at a specific air-conditioning environment a technology that uses a distributed system flow analysis technique for estimating thermal distributions and an airflow distributions within a space has been proposed as a technique for determining operating volumes such as flow rates, flow directions, temperatures, and the like of conditioned air that is supplied from air-conditioning equipment. See, for example, Japanese Unexamined Patent Application Publication 2011-089677.

In this air-conditioning controlling technology, first forward analysis of the state of air-conditioning in the air-conditioned space is performed using a distributed system flow analysis techniques, the distribution data indicating the distribution of temperatures and air flows within the air-conditioned space are calculated, and then, based on setting data wherein target temperatures are applied to specific locations within the air-conditioned space in the distribution data that is obtained, reverse analysis is performed on the temperature and airflow distributions within the air-conditioned space using distributed system flow analysis technique to back-calculate new operating volumes indicating new blowing speeds and blowing temperatures for the air-conditioned space from the blowing vents, required to cause a specific location to go to a target temperature.

The use of the forward analysis in the conventional distributed system flow analysis technique, described above, makes it possible to estimate the air-conditioning environment that would be produced through air-conditioning control of the air-conditioned space using operating volumes for the various hypothetical operating volumes. Consequently, it is possible to estimate, in advance, as solutions for achieving various air-conditioning environments, combinations of the air-conditioning environments and the operating volumes obtained, enabling the selection of any given solution from these solutions, to control an air-conditioning system based on the operating volumes included in the solution, to achieve any given air-conditioning environment easily.

On the other hand, when actually performing air-conditioning control, there are multiple objectives for the air-conditioning control, such as the operating policies of the administrators who control the air-conditioned space, and the desires of the users who use the air-conditioned space. With such objectives, there are objectives that have mutual trade-off relationships. For example, while typically the objectives for air-conditioning control include energy conservation and comfort, these have a trade-off relationship.

Because of this, if a solution for use in air-conditioning control is selected from solutions that have been estimated in advance, it is important to extract the Pareto solutions (the optimal solutions) as solutions that consider the trade-offs between such objectives. A Pareto solution is a solution wherein, in order to improve the value of one objective function it is necessary to adversely affect the value of one or more other objective functions, that is, it is a compromise solution. Specifically, a Pareto solution is a solution that provides a better evaluation than other solutions under specific conditions.

FIG. 5 is an explanatory diagram illustrating Pareto solutions. Here two objectives for air-conditioning control having a trade-off relationship, specifically energy conservation and comfort, are selected, and based on the respective evaluation values wherein the objective functions for evaluating these objectives are calculated and symbols for various solutions, including the Pareto solution, are plotted at coordinate locations corresponding to the evaluation values, on a display screen. As illustrated in FIG. 5, a Pareto solution is a solution wherein, if an achievement level for one, namely energy conservation (or comfort) is selected, air-conditioning control is achieved that maximizes the achievement level of the other, namely comfort (or energy conservation) while satisfying the achievement level for energy conservation (or comfort). Consequently, a Pareto solution can be understood to be a solution that takes into consideration the balance between these objectives.

If one of the Pareto solutions is selected in this way from among the plurality of Pareto solutions that indicate the operating volumes for controlling the air-conditioning environment and the operating volumes for that Pareto solution are provided to the air-conditioning system, then it will be possible to perform air-conditioning control taking into account balance among a plurality of objectives regarding air-conditioning control, such as the operating policies by the administrators and the desires of the users, and the like.

However, normally for a given air-conditioning environment there is a plurality of operating volumes for controlling and maintaining the air-conditioned space in the desired air-conditioning environment. For example, if the temperature of a specific location within the air-conditioned space is to be reduced to a target temperature, there may be a method wherein the blowing speed of the air-conditioned air that is blown in from a blowing vent that exists near that location is increased, along with a method wherein the blowing temperature of the air-conditioned air that is blown in from that blowing vent is reduced instead.

Consequently, even for Pareto solutions that are close for the achievement levels for energy conservation and comfort, there will be cases wherein there are large differences between the operating volumes indicated by the respective Pareto solutions.

Moreover, if there are large differences in the operating volumes, then transitioning from the original operating volumes to the new operating volumes may require some time. For example, for the blowing temperature it is necessary to adjust the heat exchange in the air-conditioning equipment, producing a time delay depending on the time constant of the heat exchange. Moreover, even after controlling to the new blowing speed and blowing temperature, still there will be the time delay until changing to the new air-conditioning environment due to the time constants of the air distribution and heat distribution in the air-conditioned space. Because of this, when there are large differences in operating volumes it is not possible to transition the air-conditioning environment smoothly and efficiently. Moreover, such large differences in the operating volumes are also factors that contribute apprehension by the users of the air-conditioned space.

Consequently, when air-conditioning control engineers or operators select or analyze Pareto solutions based on achievement levels of objectives for air-conditioning control it is necessary to consider the efficiency and smoothness in the transition of the air-conditioning environment, as well as any discomfort or apprehension felt by the users of the air-conditioned space, and to understand also differences in the air-conditioning control between different Pareto solutions, such as differences in the operating volumes.

As in FIG. 5, described above, displaying, on a display screen, a plot of symbols for the individual Pareto solutions at coordinate locations corresponding to evaluation values, based on the respective evaluation values calculated by the objective functions makes it easy to understand the relationships between the individual Pareto solutions and the achievement levels of the individual objectives. However, there is a problem in that it is not possible to understand easily, from such a plot display, the differences in the details of the air-conditioning control between the Pareto solutions.

The present invention is to solve such problems, and an aspect thereof is to provide an air-conditioning optimal solution displaying technology to effectively understand not only achievement levels of objectives regarding air-conditioning control, but also differences in details of the air-conditioning control between Pareto solutions, based on individual Pareto solutions for achieving a given air-conditioning environment.

### SUMMARY

In order to achieve such an aspect, the present invention provides an air-conditioning control solution displaying device for estimating a plurality of solutions, indicating operating volumes, for controlling an air-conditioned space to an arbitrary air-conditioning environment, and for displaying these solutions on a screen. The air-conditioning control solution displaying device includes a distributed system flow analyzing portion that estimates, through performing distributed system flow analysis for a plurality of different operating volumes, respective state distributions that describe the air-conditioning environment produced by the operating volumes, a Pareto solution identifying portion that identifies, from solution candidates includes combinations of operating volumes and state distributions, respective Pareto solutions in relation to the objective functions through, for each solution candidate, evaluating the solution candidate based on a plurality of objective functions that have been set in advance, an indicator calculating portion that calculates one or more indicators that evaluates, for each individual Pareto solution, similarity of the detail of air-conditioning control based on the operating volumes and/or the state distributions for the Pareto solution, a similarity calculating portion that calculates, for each Pareto solution, similarity of the Pareto solution to a reference Pareto solution, based on the indicators for the Pareto solution and the indicators for the reference Pareto solution, which is selected as a reference from the Pareto solutions, and a Pareto solution displaying portion that displays a plot of symbols for the individual Pareto solutions, based on evaluation values for the individual Pareto solutions, calculated by the objective functions, at coordinate locations corresponding to the evaluation values on a display screen, and displays the symbols for the individual Pareto solutions differentiated in accordance with a similarity to the reference Pareto solution.

In one structural example of the air-conditioning control solution displaying device set forth above, the indicator calculating portion, when calculating the indicators for the Pareto solution, selects, as an indicator, one or more values from among the supply air temperature of the air-conditioned air that is supplied to the air-conditioned space, the total airflow of the air-conditioned air, and/or the blowing airflows of the blowing vents of the air-conditioned space, included in the operating volumes for the Pareto solution.

In one structural example of the air-conditioning control solution displaying device set forth above, when calculating the similarity of a Pareto solution, the similarity calculating portion calculates, for each type of indicator, the difference between the candidate indicator and the reference indicator, and calculates, as the similarity, an average value for the absolute values of the differences, a maximum value for the absolute values of the differences, or a root mean square of the differences.

Moreover, an air-conditioning control solution displaying method according to the present invention is an air-conditioning control solution displaying method using an air-conditioning control solution displaying device for estimating a plurality of solutions, indicating operating volumes, for controlling an air-conditioned space to an arbitrary air-conditioning environment, and for displaying these solutions on a screen, including: a distributed system flow analyzing step wherein a distributed system flow analyzing portion estimates, through performing distributed system flow analysis for a plurality of different operating volumes, respective state distributions that describe the air-conditioning environment of produced by the operating volumes; a Pareto solution identifying step wherein a Pareto solution identifying portion identifies, from solution candidates comprising combinations of operating volumes and state distributions, respective Pareto solutions in relation to the objective functions through, for each solution candidate, evaluating the solution candidate based on a plurality of objective functions that have been set in advance; an indicator calculating step wherein an indicator calculating portion calculates one or more indicators for evaluating, for each individual Pareto solution, similarity of the detail of air-conditioning control based on the operating volumes and/or the state distributions for the Pareto solution; a similarity calculating step wherein a similarity calculating portion calculates, for each Pareto solution, similarity of the Pareto solution to a reference Pareto solution, based on the indicators for the Pareto solution and the indicators for the reference Pareto solution, which is selected as a reference from the Pareto solutions; and a Pareto displaying step wherein a Pareto solution displaying portion not only displays a plot of symbols for the individual Pareto solutions, based on evaluation values for the individual Pareto solutions, calculated by the objective functions, at coordinate locations corresponding to the evaluation values on a display screen, but also displays the symbols for the individual Pareto solutions differentiated in accordance with a similarity to the reference Pareto solution.

In the present invention, when displaying the symbols for the individual Pareto solutions on a plot, the symbols are displayed differentiated depending on the similarities of the detail of the air-conditioning control relative to that of a reference Pareto solution. Consequently, this makes it easy to understand not just the relationships between the individual Pareto solutions and the achievement levels for the air-conditioning control objectives, but also the differences in the details of the air-conditioning control between the Pareto solutions. Because of this, when air-conditioning control engineers or operators select or analyze Pareto solutions based on achievement levels of objectives for air-conditioning control, it is easy to consider the efficiency and smoothness in the transition of the air-conditioning environment, as well as any discomfort or apprehension felt by the users of the air-conditioned space, and to understand also differences in the air-conditioning control between different Pareto solutions, such as differences in the operating volumes.

### BRIEF DESCRIPTIONS OF THE DRAWINGS

FIG. 1 is a block diagram illustrating a configuration of an air-conditioning control solution displaying device.

FIG. 2 is a flowchart illustrating the air-conditioning control solution displaying procedure in the air-conditioning control solution displaying device.

FIG. 3 is an explanatory diagram illustrating an example of displaying a plot of Pareto solutions.

FIG. 4 is a flowchart illustrating an air-conditioning control solution displaying procedure.

FIG. 5 is an explanatory diagram illustrating Pareto solutions.

### DETAILED DESCRIPTION

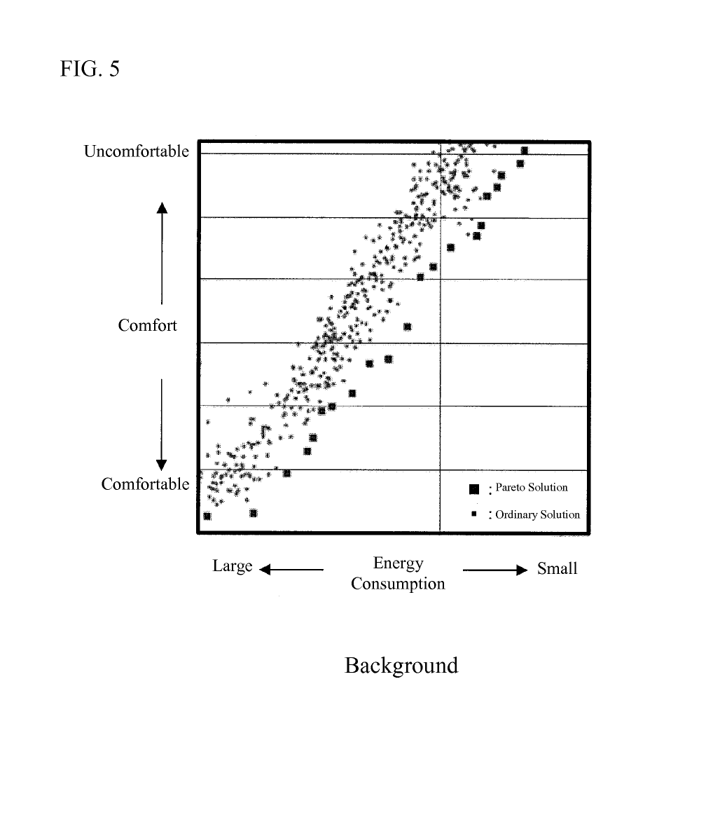

Using forward analysis in a distributed system flow analysis technique to estimate air-conditioning environments produced by controlling an air-conditioned space using a variety of hypothetical operating volumes and then identifying, from the solutions produced, the combinations of operating volumes and air-conditioning environments, the Pareto solutions that are in accordance with the various objectives for air-conditioning control, makes it possible to obtain solutions, as illustrated in FIG. 5, described above, that take into account the balance of the achievement levels for the objectives. Consequently, if one of these Pareto solutions is selected and the air-conditioning system is controlled by the operating volumes included in that Pareto solution, then it will be possible to produce easily and air-conditioning environment that takes into account balance among a plurality of objectives regarding air-conditioning control, such as the operating policies by the administrators and the desires of the users, and the like.

However, as described above, even if these Pareto solutions are Pareto solutions wherein the achievement levels of the respective objectives are similar, as described above, the operating volumes indicated by the respective Pareto solutions may be very different. Because of this, there is little relationship between the distribution location of the Pareto solution and the values of the operating volumes.

Moreover, if the operating volumes are very different, then, as described above, in some cases it will take time to transition from the original operating volumes to the new operating volumes, making it impossible to transition the air-conditioning environment smoothly and effectively. Moreover, such large differences in the operating volumes are also factors that contribute apprehension by the users of the air-conditioned space.

The aspect of the present invention is to enable a quantitative and comprehensive analysis of the differences in the operating volumes between such Pareto solutions through indicators based on knowledge regarding air-conditioning control.

Specifically, indicators of one or more types, established in advance, are each calculated based on a reference Pareto solution that was used to achieve the air-conditioning environment prior to a transition and based on a new Pareto solution used to achieve the air-conditioning environment after the transition, and the differences between the respective indicators are summed to calculate a similarity between the two Pareto solutions, and symbols for the individual Pareto solutions are displayed differentiated based on these similarities, when displaying a plot of the symbols for Pareto solutions in coordinate locations corresponding to the evaluation values on a display screen based on the respective evaluation values calculated for the objective functions, as illustrated in FIG. 5, described above.

A form for carrying out the present invention will be explained next in reference to the figures.

### STRUCTURE OF THE PRESENT EXAMPLE

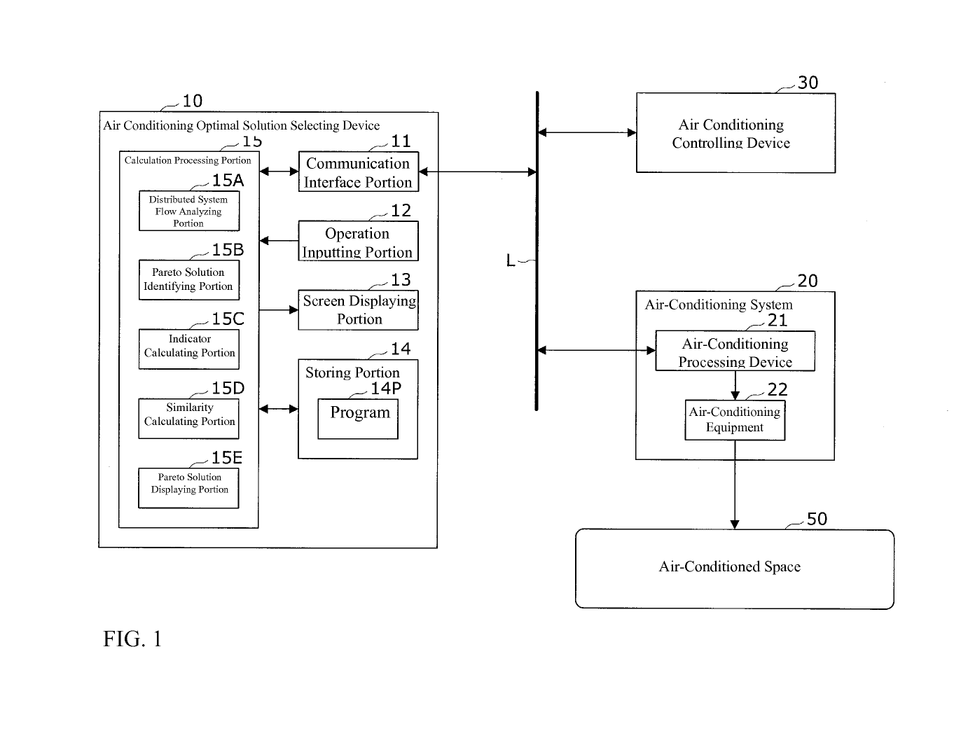

An air-conditioning control solution displaying device 10 according to the present example will be explained first in reference to FIG. 1. FIG. 1 is a block diagram illustrating a configuration of an air-conditioning control solution displaying device.

The air-conditioning control solution displaying device 10 comprises, overall, an information processing device such as a personal computer or a server, and has a function for estimating a plurality of solutions indicating control volumes for controlling to an arbitrary air-conditioning environment an air-conditioned space 50, and for displaying those solutions on a screen.

As the primary structure thereof, the air-conditioning system 20 is provided with an air-conditioning processing device 21, and air-conditioning equipment 22.

The air-conditioning processing device 21 is structured, as a whole, from an information processing device such as a personal computer, a server device, or the like, and has a function for controlling entirety of the air-conditioning environment of the air-conditioned space 50, by controlling the air-conditioned air that is blown into the air-conditioned space 50 from the individual blowing vents by the air-conditioned device 22, based on operating quantities sent through communication lines L from the air-conditioning controlling device 30 or the air-conditioning control solution displaying device 10.

The air-conditioning controlling device 30 comprises, overall, an information processing device such as a personal computer or a server, and has a function for controlling the air-conditioned space 50 to a desired air-conditioning environment through controlling an air-conditioning system 20.

The air-conditioning control solution displaying device 10 is provided with a communication I/F portion 11, an operation inputting portion 12, a screen displaying portion 13, a storing portion 14, and a calculation processing portion 15, as the primary functional components thereof.

The communication I/F portion 11 is made from a dedicated data communication circuit, and has the function of performing data communication with external devices, such as an air-conditioning system 20 or the air-conditioning controlling device 30, connected through a communication line L.

The operation inputting portion 12 is made from an operation inputting device, such as a keyboard or a mouse, and has a function for detecting operations by an operator and outputting them to the calculation processing portion 15.

The screen displaying portion 13 is made from a screen displaying device such as an LCD or a PDP, and has a function for displaying, on a screen, various types of information, such as an operating menu and input/output data, in accordance with instructions from the calculation processing portion 15.

The storing portion 14 is made from a storage device, such as a hard disk or a semiconductor memory, and has a function for storing various types of processing data and a program 14P used by the calculation processing portion 15.

The program 14P is a program that is read out and executed by the calculation processing portion 15, and is stored in advance into the storing portion 14 through the communication I/F portion 11 from an external device or recording medium.

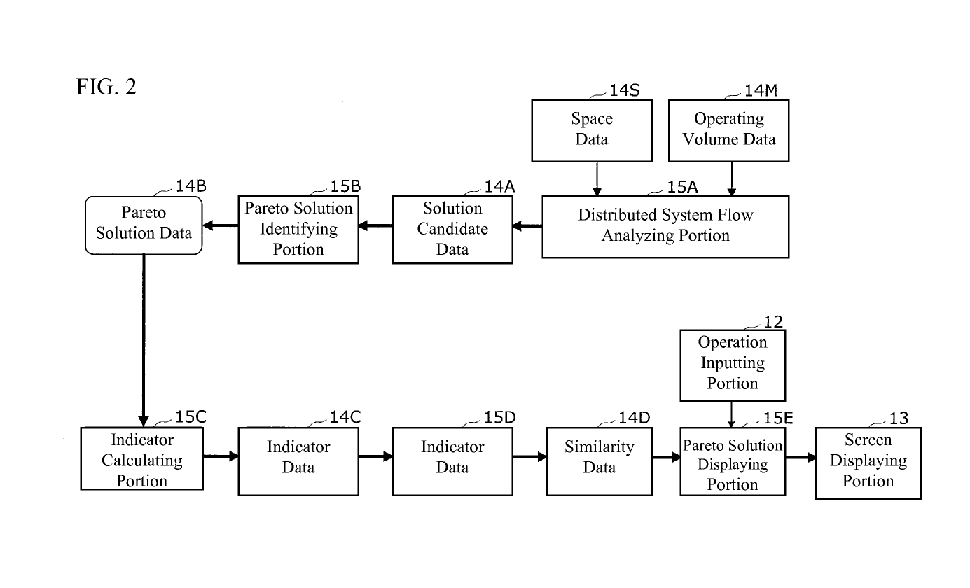

The calculation processing portion 15 has a microprocessor, such as a CPU and the peripheral circuitry thereof, and has the function of embodying a variety of processing portions through reading in and executed the program 14P from the storing portion 14. FIG. 2 is a flow chart illustrating the air-conditioning control solution displaying process in the air-conditioning control solution displaying device.

As the primary processing portions for embodying the calculation processing portion 15 there are a distributed system flow analyzing portion 15A, a Pareto solution identifying portion 15B, an indicator calculating portion 15C, a similarity calculating portion 15D, and a Pareto solution displaying portion 15E.

The distributed system flow analyzing portion 15A has a function for selecting a different operating volume from a range of possible operating volumes for the air-conditioning equipment 22 based on operating volume data 14M, a function for estimating respective state distributions indicating the air-conditioning environments that can be produced by these operating volumes through distributed system flow analysis of selected operating volumes based on space data 14S, and a function for outputting, as solution candidate data 14A, combinations of these operating volumes and state distributions.

The distributed system flow analysis technique is a technique for calculating, through numerical calculations, the distributions of temperature, air flow rates, and the like, from boundary conditions based on CFD (computational fluid dynamics). In a typical CFD, the space of interest is divided into a mesh of element spaces, and the heat flow between adjacent element spaces is analyzed. The distributed system flow analyzing portion 15A has a function for performing a heat flow analysis process on the air-conditioned space 50 using this distributed system flow analysis technique, to estimate state distributions, such as temperature distributions and airflow distributions, of the air-conditioned space 50 from operating volume data 14M and space data 14S regarding the air-conditioned space 50. An actual CFD forward analysis procedure that is executed through a heat flow analysis procedure may use a known technology. See, for example, KATO, Shinsuke; KOBAYASHI, Hikaru; and, MURAKAMI, Shuzo: “Scales for Assessing Contribution of Heat Sources and Sinks to Temperature Distributions in Room by Means of Numerical Simulation,” Institute of Industrial Science, University of Tokyo, Air-Conditioning and Sanitation Engineering Reports No. 69, pp. 39 to 47, April 1998.

The operating volume data 14M includes data indicating the state of control of the conditioned air in the air-conditioning system 20, such as the blowing airflow rates and blowing temperatures for the conditioned air that is blown from the individual blowing vents that are provided in the air-conditioned space 50, for example, and also the total flow rates and temperatures of the conditioned air in the air-conditioning equipment.

The space data 14S includes various types of data that form the setting conditions when performing the heat flow analysis processes, such as spatial condition data that represent locations and shapes pertaining to the structural elements that have an impact on the air-conditioning environment of the air-conditioned space 50, such as locations and shapes pertaining to the air-conditioned space 50, conditioned air blowing vents formed in the air-conditioning system 20, and the like, along with, for example, heat-producing object data that indicate the layout position, amount of heat produced, and shape of each heat-producing object that is disposed in the air-conditioned space 50.

The Pareto solution identifying portion 15D has a function for evaluating, for each solution candidate data 14A, which comprises a combination of operating volumes and state distributions, obtained from the distributed system flow analyzing portion 15A, the applicable solution candidates, based on a plurality of objective functions that are set in advance, a function for identifying Pareto solutions (optimal solutions) for these objective functions, from among these candidate solutions, based on the evaluation values for the individual candidate solutions, obtained with these objective functions, and a function for outputting Pareto solution data 14B, comprising a combination of the operating volumes and the state distributions for the identified Pareto solutions.

A Pareto solution is a solution wherein, in order to improve the value of one objective function it is necessary to adversely affect the value of one or more other objective functions, that is, it is a compromise solution. Specifically, a Pareto solution is a solution that provides a better evaluation than other solutions under specific conditions.

The objective functions may use known functions for evaluating air-conditioning control, such as the energy conservation and comfort, of the solutions based on the operating volumes for achieving the various types of air-conditioning environments and on state distributions representing the air-conditioning environments. For example, for energy conservation, this can be calculated from the calorific value Qi, described below, and for comfort, the comfort indicator PMV, described below, may be used.

The indicator calculating portion 15C has a function for calculating one or more types of indicators for evaluating the similarity of the detail of the air-conditioning control based on the operating volumes and/or state distributions in relation to the Pareto solution for each Pareto solution within the Pareto solution data 14B, and a function for outputting indicator data 14C indicating the individual indicator values for the Pareto solutions.

As the indicators there are supply air temperature, total airflow, calorific value, comfort, pressure loss, and the like. For any of these indicators, there is a tendency for the difference in air-conditioning control to be larger, and for the similarity of the detail of the air-conditioning control to be smaller, the larger the change in the indicator. For these indicators, the indicator calculating portion 15C may select arbitrarily a plurality of indicator types depending on the objectives for air-conditioning control, the air-conditioning controlling mode prior to the transition or after the transition, or in response to an instruction operation.

The supply air temperature may use the temperature of the air-conditioned air supplied to the air-conditioned space 50. The air is blown, by a fan, to the blowing vents in the air-conditioned space 50 through ducts after the temperature thereof is adjusted through heat exchange in the air-conditioning equipment, and supplied into the air-conditioned space 50 by fans of VAVs (Variable Air Volume devices) equipped in the blowing vents. At this time, the heat exchange in the air-conditioning equipment has some degree of a time constant, where the larger the scope of change in the supply air temperature, the longer the time required for the transition. The fans equipped in the air-conditioning equipment also have time constants, where the greater the scope of change in the RPMs thereof, the slower the change in the total airflow will be; however, typically when the supply air temperature is changed, the total airflow is also changed in cooperation therewith, so the total airflow may be omitted from the indicators.

The calorific value may use the amount of energy required when transitioning to the air-conditioning environment produced by the Pareto solution. For an arbitrary Pareto solution Yi, if the indoor temperature of the air-conditioned space 50 is defined as Tri (° C.), the supply air temperature of the air-conditioned air that is supplied to the air-conditioned space 50 is defined as Tsi (° C.), the total air flow of the air-conditioned air is defined as Vi (m³/h), the air density is defined as ρ (kg/m³), and the specific heat at a constant pressure of the air is defined as Cp(J/kgK), then the calorific value Qi can be calculated by Equation (1), below.

$$\begin{matrix}[ Expression 1 ] & \\ Qi = \frac{( Tri - Tsi ) \times Vi \times ρ \times Cp}{3600} & ( 1 )\end{matrix}$$

For the comfort, a comfort indicator PMV for the office workers in the air-conditioned space 50 may be calculated. The comfort indicator PMV is a predicted mean report of a perception of being hot or cold, commonly referred to as a “predicted mean vote,” and is an indicator of the perception of being hot or cold, as felt by humans. It may be calculated through a known calculation method based on the air temperature, flow rate, and humidity at the location of the office worker, and the amount of clothing worn by the office worker.

The pressure loss may use a change in pressure accompanying the transition of the air-conditioning environment in the air-conditioned space 50. When the amount of pressure loss in the blower system as a whole is large, then the energy loss will be large. Specifically, if the balance of VAV openings, between the individual VAVs, is poor, and the VAV opening is large for a particular VAV, causing an imbalance in the total air flow, the pressure loss will be large. If, for an arbitrary Pareto solution Yi, the number of VAVs is defined as K, the flow rate in an arbitrary VAVk thereof is defined as Vk, and the maximum value of the Vk's is defined as Vmax, the pressure loss Pi can be calculated through Equation (2), below.

$$\begin{matrix}[ Expression 2 ] & \\ Pi = {\sum }_{k = 1}^{K} ( Vmax - Vk ) & ( 2 )\end{matrix}$$

The similarity calculating portion 15D has a function for normalizing the indicator values of the individual Pareto solutions included in the indicator data 14C, a function for calculating the similarities of the Pareto solutions to a reference Pareto solution, for each Pareto solution, based on candidate indicators for that Pareto solution and on reference indicators for the reference Pareto solution that is selected as a reference from among the Pareto solutions, and a function for outputting similarity data 14D that indicates the degrees of similarity of the individual Pareto solutions.

For the normalization, the individual indicator values may be corrected, for each indicator type, so that the range from the minimum value to the maximum value for the indicator is from 0 to 1. At this time, if, between the indicator types, there are differences in significance to be considered at the time of calculating similarities, weightings may be applied based on weightings that are set in advance for the individual types of indicators.

The reference Pareto solution is the Pareto solution corresponding to the air-conditioning environment prior to the transition, and when performing a repeated selection of a Pareto solution, is the Pareto solution that was selected up until that point, where the other Pareto solutions are candidates indicating post-transition states.

The similarities may use to representative values obtained by calculating differences between the reference indicators and the candidate indicators, for each type of indicator, and then performing a statistical process on these differences between the reference indicators of the reference Pareto solution and the candidate indicators for a single Pareto solution that is a candidate. Here three similarity calculating methods will be explained as specific examples.

The first similarity calculating method is a method wherein an average value is calculated for the absolute values of the differences between the reference indicators and the candidate indicators. If the reference Pareto solutions are defined as Ys, the Pareto solutions that are candidates are defined as Yi, and the number of types of indicators is defined as N, then if the indicator value of indicator type n in Ys is defined as Xsⁿ and the indicator value of indicator type n in Yi is defined as Xiⁿ, then the similarity Ri of Yi in relation to Ys is calculated through the following Equation (3).

$$\begin{matrix}[ Expression 3 ] & \\ Ri = \frac{1}{N} {\sum }_{n = 1}^{N} \vert {X}_{i}^{n} - {X}_{s}^{n} \vert & ( 3 )\end{matrix}$$

The second similarity calculating method is a method wherein the maximum value of the absolute values of the differences between the reference indicators and the candidate indicators is calculated. If the function for selecting the maximum value from a plurality of elements is defined as max ( ), then the similarity Ri of Yi in relation to Ys is calculated through the following Equation (4).

[Expression 4]

Ri=max(|Xi¹−Xs¹|,|Xi²−Xs²|, . . . , |Xi^{N}−Xs^{N}|) (4)

The third similarity calculating method is a method wherein the root mean square of the differences between the reference indicators and the candidate indicators is calculated. The similarity Ri of Yi in relation to Ys is calculated through Equation (5), which follows.

$$\begin{matrix}[ Expression 5 ] & \\ Ri = \sqrt{\frac{1}{N} {\sum }_{n = 1}^{N} {( {X}_{i}^{n} - {X}_{s}^{n} )}^{2}} & ( 5 )\end{matrix}$$

The Pareto solution displaying portion 15E has a function for displaying symbols differentiated depending on the similarity to a reference Pareto solution when displaying a plot of the individual Pareto solutions Yi on the screen of the screen displaying portion 13, and a function for sending, to the air-conditioning system 20, operating volumes for a Pareto solution of a symbol that is selected on the screen.

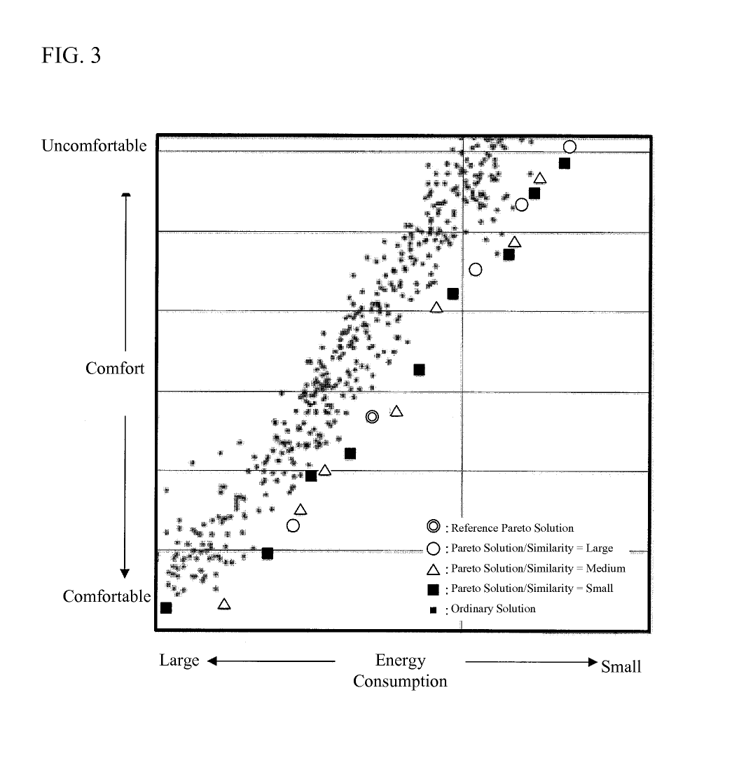

FIG. 3 is an example display of a plot of Pareto solutions. Here two objectives for air-conditioning control having a trade-off relationship, specifically energy conservation and comfort, are selected, and based on the respective evaluation values wherein the objective functions for evaluating these objectives are calculated and symbols for various solutions, including the Pareto solution, are plotted at coordinate locations corresponding to the evaluation values, on a display screen. In addition to this, the symbols for the individual Pareto solutions are displayed differentiated depending on the similarity to a reference Pareto solution P.

In the specific example illustrated in FIG. 3, the degrees of similarity of the individual Pareto solutions are categorized into three levels of differentiated display groups based on category threshold values for the values of similarities, set in advance, where the Pareto solutions with high similarities are displayed on the plot as circle symbols, the Pareto solutions with medium similarities are displayed on the plot as triangle symbols, and the Pareto solutions with low similarities are displayed on the plot as square symbols. Moreover, the reference Pareto solution is displayed on the plot as a double circle symbol. When it comes to the method for the differentiated display, common differentiated displays, such as by the colors or sizes of the symbols, rather than the shapes of the symbols, may be used, and the number of different differentiated display groups may be set arbitrarily.

### OPERATION OF THE PRESENT EXAMPLE

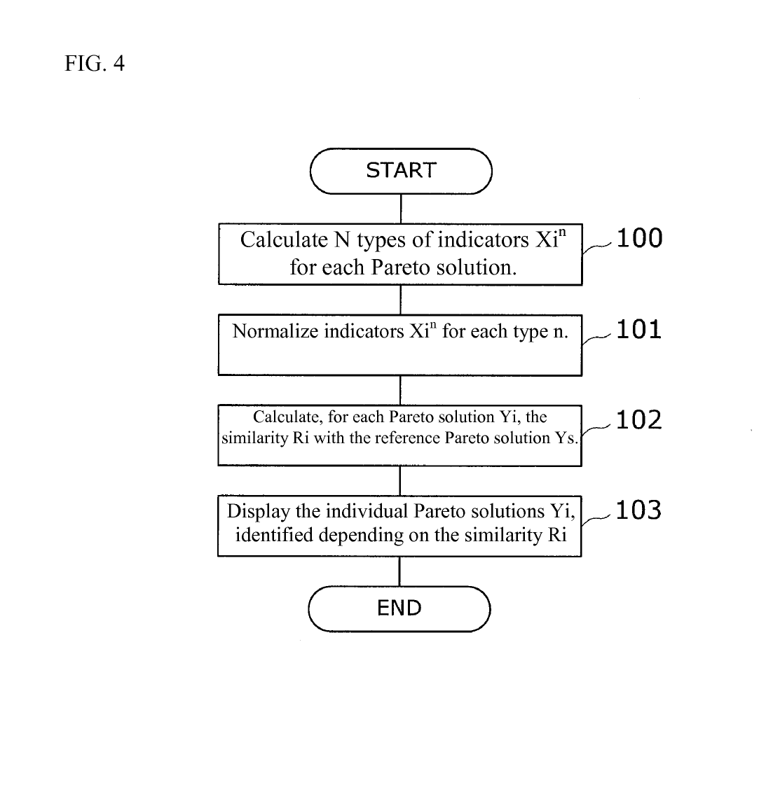

The operation of the air-conditioning control solution displaying device 10 according to the present example will be explained next in reference to FIG. 2 and FIG. 4. FIG. 4 is a flowchart showing an air-conditioning optimal solution displaying procedure.

The calculation processing portion 15 of the air-conditioning control solution displaying device 10 begins the air-conditioning optimal solution displaying procedure of FIG. 4 at the time of startup or in response to an operator operation. Note that the Pareto solution data 14B is stored in the storing portion 14 in advance, prior to starting the execution of the air-conditioning optimal solution displaying procedure.

First, for each Pareto solution Yi that is included in the Pareto solution data 14B that is read out from the storing portion 14, the indicator calculating portion 15C calculates, and outputs as indicator data 14C, N types of indicators Xiⁿ, based on the operating volumes and/or state distributions, for that Pareto solution (Step 100).

Following this, the similarity calculating portion 15D normalizes the indicators Xiⁿ for each Pareto solution Yi included in the indicator data 14C that has been outputted from the indicator calculating portion 15C (Step 101), and then, for each Pareto solution Yi, calculates the similarity Ri of the applicable Pareto solution Yi in relation to the reference Pareto solution Ys, and stores the results in the storing portion 14 as similarity data 14D (Step 102).

Thereafter, the Pareto solution displaying portion 15E not only displays a plot of the symbols for the individual Pareto solutions Yi, based on the evaluation values of the individual Pareto solutions Yi calculated by the objective functions, at coordinate locations corresponding to the evaluation values in the display screen of the screen displaying portion 13, but also displays the symbols for the individual Pareto solutions Yi differentiated in accordance with the similarity Ri in relation to the reference Pareto solution Ys (Step 104), to conclude the series of air-conditioning controlling procedures.

Consequently, in, for example, FIG. 3, described above, the Pareto solutions with high similarities to the reference Pareto solution Ys are displayed in the plot as circle symbols, the Pareto solutions with medium similarities are displayed in the plot with triangle symbols, and Pareto solutions with low similarities are displayed in the plot with square symbols. Moreover, the reference Pareto solution is displayed on the plot as a double circle symbol. Doing so makes it easy to understand, from the coordinate locations at which the individual symbols are displayed on the plot, the relationships between the individual Pareto solutions and the achievement levels for energy conservation and comfort, along with making it easy to understand, from the shapes of the individual symbols, the similarities in terms of the detail of air-conditioning control, to the reference Pareto solution Ys.

### EFFECTS OF THE PRESENT EXAMPLE

In this way in the present example, for each Pareto solution the indicator calculating portion 15C calculates indicators of one or more types for evaluating the similarity of the details of the air-conditioning control based on the operating volumes and/or state distributions for the applicable Pareto solution, the similarity calculating portion 15D calculates, for each Pareto solution, the similarity of the Pareto solution to a reference Pareto solution, based on the indicators for the Pareto solution and the indicators for a reference Pareto solution that is selected as a reference from among the Pareto solutions, and the Pareto solution displaying portion 15E not only displays a plot of symbols for the individual Pareto solutions at coordinate locations corresponding to the evaluation values in the display screen, based on the evaluation values of the individual Pareto solutions, calculated by the objective functions, but also displays symbols for the individual Pareto solutions differentiated based on similarities to a reference Pareto solution.

Given this, when displaying the symbols for the individual Pareto solutions on a plot, the symbols are displayed differentiated depending on the similarities of the detail of the air-conditioning control relative to that of a reference Pareto solution.

Consequently, this makes it easy to understand not just the relationships between the individual Pareto solutions and the achievement levels for the air-conditioning control objectives, but also the differences in the details of the air-conditioning control between the Pareto solutions. Because of this, when air-conditioning control engineers or operators select or analyze Pareto solutions based on achievement levels of objectives for air-conditioning control, it is easy to consider the efficiency and smoothness in the transition of the air-conditioning environment, as well as any discomfort or apprehension felt by the users of the air-conditioned space, and to understand also differences in the air-conditioning control between different Pareto solutions, such as differences in the operating volumes.

### EXPANDED EXAMPLES

While the present invention was explained above in reference to examples, the present invention is not limited by the examples set forth above. The structures and details of the present invention may be modified in a variety of ways, as can be understood by those skilled in the art, within the scope of the present invention.

1. An air-conditioning control solution displaying device for estimating a plurality of solutions, indicating operating volumes, for controlling an air-conditioned space to an arbitrary air-conditioning environment, and for displaying these solutions on a screen, the device comprising:
a distributed system flow analyzing portion that estimates, through performing distributed system flow analysis for a plurality of different operating volumes, respective state distributions that describe the air-conditioning environment produced by the operating volumes;
a Pareto solution identifying portion that identifies, from solution candidates including combinations of operating volumes and state distributions, respective Pareto solutions in relation to the objective functions through, for each solution candidate, evaluating the solution candidate based on a plurality of objective functions that have been set in advance;
an indicator calculating portion that calculates one or more indicators to evaluate, for each individual Pareto solution, similarity of the detail of air-conditioning control based on the operating volumes and/or the state distributions for the Pareto solution;
a similarity calculating portion that calculates, for each Pareto solution, similarity of the Pareto solution to a reference Pareto solution, based on the indicators for the Pareto solution and the indicators for the reference Pareto solution, which is selected as a reference from the Pareto solutions; and
a Pareto solution displaying portion that displays a plot of symbols for the individual Pareto solutions, based on evaluation values for the individual Pareto solutions, calculated by the objective functions, at coordinate locations corresponding to the evaluation values on a display screen, and displays the symbols for the individual Pareto solutions differentiated in accordance with a similarity to the reference Pareto solution.

2. The air-conditioning control solution displaying device as set forth in claim 1, wherein
the indicator calculating portion, when calculating the indicators for the Pareto solution, selects, as an indicator, one or more values from among the supply air temperature of the air-conditioned air that is supplied to the air-conditioned space, the total airflow of the air-conditioned air, and/or the blowing airflows of the blowing vents of the air-conditioned space, included in the operating volumes for the Pareto solution.

3. An air-conditioning control solution displaying device as set forth in claim 1, wherein
when calculating the similarity of a Pareto solution, the similarity calculating portion calculates, for each type of indicator, the difference between the candidate indicator and the reference indicator, and calculates, as the similarity, an average value for the absolute values of the differences, a maximum value for the absolute values of the differences, or a root mean square of the differences.

4. An air-conditioning control solution displaying method using an air-conditioning control solution displaying device for estimating a plurality of solutions, indicating operating volumes, for controlling an air-conditioned space to an arbitrary air-conditioning environment, and for displaying these solutions on a screen, the method comprising:
a distributed system flow analyzing step of estimating by a distributed system flow analyzing portion, through performing distributed system flow analysis for a plurality of different operating volumes, respective state distributions that describe the air-conditioning environment produced by the operating volumes;
a Pareto solution identifying step of identifying by a Pareto solution identifying portion, from solution candidates comprising combinations of operating volumes and state distributions, respective Pareto solutions in relation to the objective functions through, for each solution candidate, evaluating the solution candidate based on a plurality of objective functions that have been set in advance;
an indicator calculating step of calculating by an indicator calculating portion one or more indicators for evaluating, for each individual Pareto solution, similarity of the detail of air-conditioning control based on the operating volumes and/or the state distributions for the Pareto solution;
a similarity calculating step of calculating by a similarity calculating portion, for each Pareto solution, similarity of the Pareto solution to a reference Pareto solution, based on the indicators for the Pareto solution and the indicators for the reference Pareto solution, which is selected as a reference from the Pareto solutions; and
a Pareto displaying step of displaying by a Pareto solution displaying portion a plot of symbols for the individual Pareto solutions, based on evaluation values for the individual Pareto solutions, calculated by the objective functions, at coordinate locations corresponding to the evaluation values on a display screen, and displaying by the Pareto solution displaying portion the symbols for the individual Pareto solutions differentiated in accordance with a similarity to the reference Pareto solution.
